(19) United States
(12) Patent Application Publication
(10) Pub. No.: US 2007/0011049 A1
(43) Pub. Date: Jan. 11, 2007

(54) Intelligent, personalized commerce chain

(76) Inventor: Jeffrey Scott Eder, Mill Creek, WA (US)

Correspondence Address: ASSET TRUST, INC., 2020 MALTBY ROAD, SUITE 7362, BOTHELL, WA, 98021, US

(21) Appl. No.: 11/358,196

(22) Filed: Feb. 21, 2006

Related U.S. Application Data
(60) Provisional application No. 60/697,441, filed on Jul. 9, 2005.

(51) Int. Cl. G06Q 30/00

(52) U.S. Cl. 705/14

(57) ABSTRACT

An automated method and system (100) for advertising, configuring, offering, selling, producing, delivering and/or servicing offerings that are appropriate to the context of a specific individual, group or organization. The system incorporates a program storage device to guide the completion of the required processing. The offerings may be sold “as is” and/or they may be customized (aka personalized) to match a specific context and/or characteristic(s) of the individual, group or organization.

### CROSS REFERENCE TO RELATED APPLICATIONS AND PATENTS

This application is a non provisional of provisional application 60/697,441 filed Jul. 7, 2005 which is incorporated herein by reference. The subject matter of this application is also related to the subject matter of U.S. patent application Ser. No. 10/237,021 filed Sep. 9, 2002, U.S. patent application Ser. No. 10/242,154 filed Sep. 12, 2002, U.S. patent application Ser. No. 10/071,164 filed Feb. 7, 2002, U.S. patent application Ser. No. 10/717,026 filed Nov. 19, 2003, U.S. patent application Ser. No. 11/094,171 filed Mar. 31, 2005, U.S. patent application Ser. No. 10/746,673 filed Dec. 24, 2003, U.S. patent application Ser. No. 11/167,685 filed Jun. 27, 2005, U.S. patent application Ser. No. 11/262,146 filed Oct. 28, 2005 and U.S. patent application Ser. No. 11/268,081 filed Nov. 7, 2005.

### BACKGROUND OF THE INVENTION

This invention relates to a method of and system for advertising, configuring, offering, selling, producing, delivering and/or servicing information (aka media), products and/or services that are appropriate to the context of a specific individual, group or organization. The system incorporates a program storage device to guide the completion of the required processing. The information, products and/or services may be sold “as is” and/or they may be customized (aka personalized) to match a specific context and/or characteristic(s) of the individual, group or organization.

### SUMMARY OF THE INVENTION

It is a general object of the invention described herein to provide a novel and useful system for advertising, configuring, offering, selling, delivering and/or servicing information, media, products and/or services that are appropriate to the context of a specific individual, group or organization (hereinafter, entity). The information, media, products and/or services may be sold “as is” and/or they may be customized (aka personalized) to match a specific context and/or characteristic(s) of an entity.

The information regarding the context and characteristics of an entity are continuously analyzed and updated using an entity context system (30) similar to that described in cross referenced U.S. patent application Ser. No. 10/717,026. The entity context system (30), in turn communicates with a number of other systems (please see FIG. 1) as required to support the entity and complete one or more of the five steps in the personalized commerce chain.

By eliminating many of the gaps in information available to personnel in each link (or step) of the commerce chain, the system described herein enables the just-in-time development and delivery of information, products and/or services that are tailored to the exact needs of the entity. The electronic linkages also provide the potential to eliminate the waste that comes from developing and shipping products that don't match current needs.

### BRIEF DESCRIPTION OF DRAWINGS

These and other objects, features and advantages of the present invention will be more readily apparent from the following description of the one embodiment of the invention in which:

FIG. 1 is a block diagram showing the major systems in the intelligent personalized commerce chain;

FIG. 2 is a diagram showing the five primary steps in a personalized commerce chain;

FIG. 3 is a block diagram of an implementation of the Complete Context™ Commerce System (50) described herein;

FIG. 4 is a diagram showing the data windows that are used for receiving information from and transmitting information to a system operator (21) and/or a customer (22) during system processing;

FIG. 5 is a diagram showing the tables in the application database (51) described herein that are utilized for data storage and retrieval during the processing in the innovative Complete Context™ Commerce System (50); and

FIG. 6A and FIG. 6B are block diagrams showing the sequence of steps in the present invention used for specifying system settings and operating the Complete Context™ Commerce System (50).

### DETAILED DESCRIPTION OF ONE EMBODIMENT

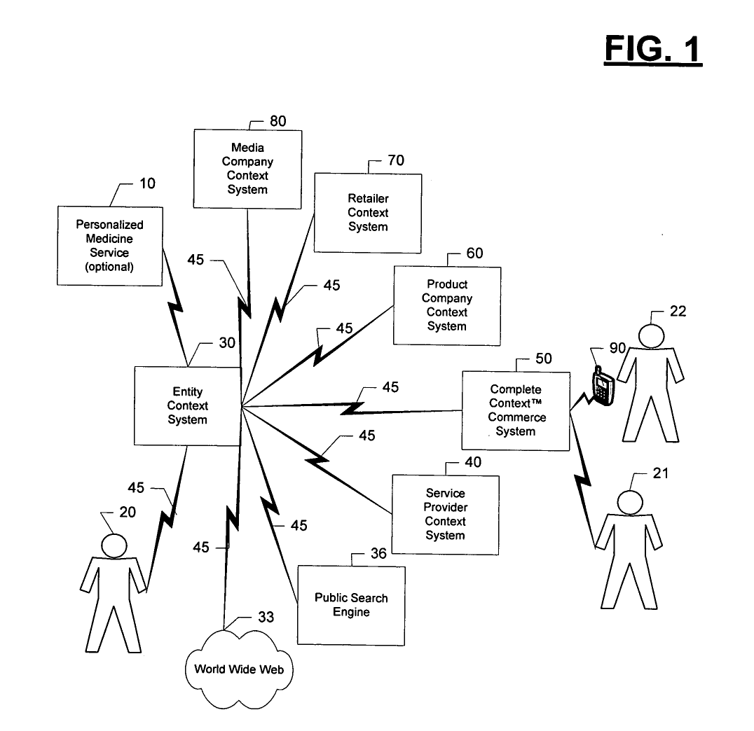

FIG.1 provides an overview of the systems that are used to define an intelligent personalized commerce chain. The intelligent personalized commerce chain is used for advertising, configuring, offering, selling, delivering and/or servicing information, media products and/or services (hereinafter, collectively and/of individually an offering) that are appropriate to the context of a specific entity.

In accordance with the present invention, the starting point for processing is an entity context system (30) that identifies the current context for an entity using as many as eight of the primary layers (or aspects) of context as well as other aspects of context that are appropriate as described in cross referenced U.S. patent application Ser. No. 10/717,026. As shown in FIG. 1, the context of any entity may be influenced by information from a personalized medicine service (10) similar to the one described in U.S. patent application Ser. No. 11/094,171.

An individual's health can have a wide variety of effects on the context of an individual.

For example, a chronic illness can dictate virtually every action that an individual needs to take during every minute of every day. On the other extreme, a cold or virus may have a minor impact on an individual's behavior for a day or two. Because the impact is generally limited to specific elements of context and or resources over a specific time period, the entity context system (30) treats the input from the personalized medicine service (10) in a manner similar to that described in U.S. patent application Ser. No. 11/094,171 for a project. Like a project, each illness would be expected to have an impact on one or more specific elements and/or resources for a specified period of time. In some cases, the change in elements and/or resources may be permanent—also like a project. The actual impact and amount of time will of course vary and the personalized medicine service (10) provides the entity context system (30) with the input required to adjust the current and forecast context for an entity in response to the actual evolution of an illness or condition. As noted in FIG. 1, the use of a personalized medicine service (10) to influence the context of an entity is optional.

Before going on to discuss the interaction of the entity context system (30) with the other systems that comprise the intelligent personalized commerce chain, it should be noted that the present invention incorporates five improvements to the personalized medicine service (10) described in U.S. patent application Ser. No. 11/094,171 and the entity context system (30, 40, 60, 70 and 80) described in cross referenced U.S. patent application Ser. No. 10/717,026.

The first improvement is that the timing of the delivery of Complete Context™ Scout (616) reports, the Complete Context™ Journal (630) and/or the Complete Context™ Review (607) reports described therein is influenced by a predictive model that identifies the time(s) when the entity (or the entity representative) is most likely to be unreceptive to receiving an interruption. More specifically, the receptiveness to interruption is evaluated in an automated fashion by a predictive model in the Complete Context™ Metrics and Rules System (611) that processes input from sensors to produce an interruptibility score—the higher the score the less likely the user (20) is likely to want an interruption. It is now well established that a number of activities are associated with the desire of an individual to work without interruption and that these activities can be reliably and unobtrusively detected by sensors. While the desire to proceed without interruption is generally respected, the entity context system (30) balances this desire against the criticality of the information that is contained in a Complete Context™ Review (607) report, Complete Context™ Scout (616) report and/or Complete Context™ Journal (630) to ensure optimal support under all circumstances. Criticality is determined on the basis of likely change in behavior using the Complete Context™ Scout (616) analysis. The Complete Context™ Metrics and Rules System (611) will adjust the over-ride level as part of the normal learning process detailed in the cross referenced applications.

The second improvement to the personalized medicine service (10) and the entity context system (30) involves the use of spectral risk measures to adjust the “objective” analysis of risk completed by these entity contextsystem (30) or personalized medicine service (10) for the behavior of the entity (or the entity representative). It is well established that an individual's perception of the severity of a risk is in many cases not in agreement with the actual “objective” measure of said risk. The use of spectral risk measures provides the ability to adjust the entity context to the perceived level or risk as opposed to the objective measure of risk.

The third improvement to the personalized medicine service (10) and the entity context system (30) involves improvements to the associated Complete Context™ Scout (616) and Complete Context™ Search (609) services. More specifically, the improvements comprise the addition of suffusion, weighted suffusion (suffusion algorithm with results weighted for relative impacts identified by the entity context system (30)), trusted suffusion (weighted suffusion algorithm results weighted for reliability of source), shrank, weighted shrank (shrank algorithm with results weighted for relative impacts identified by the entity context system (30)), trusted shrank (weighted shrank algorithm weighted for reliability of source) algorithms and combinations thereof to the algorithms used by these applications (10 and 30) to identify relevant data, information and/or knowledge for an entity context.

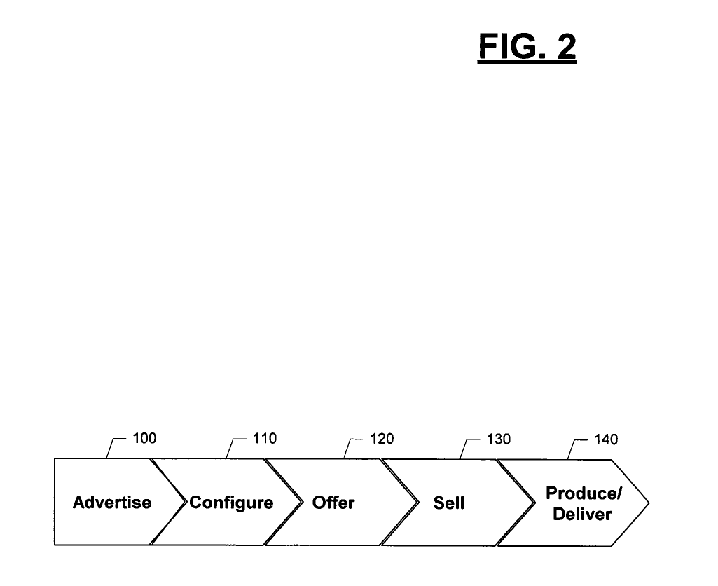

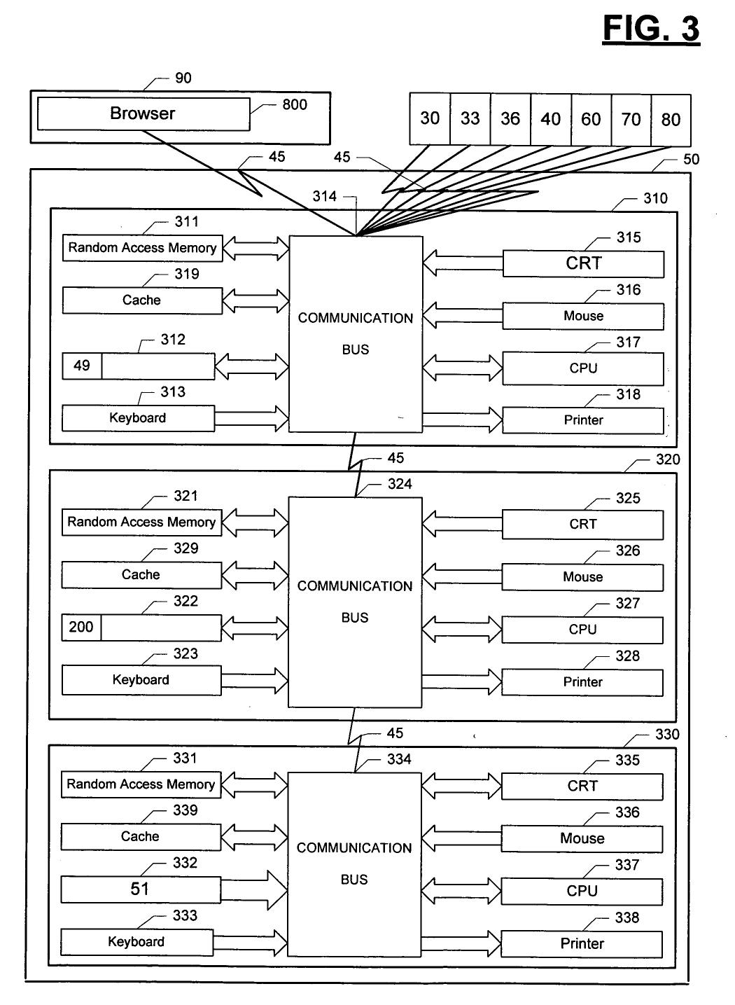

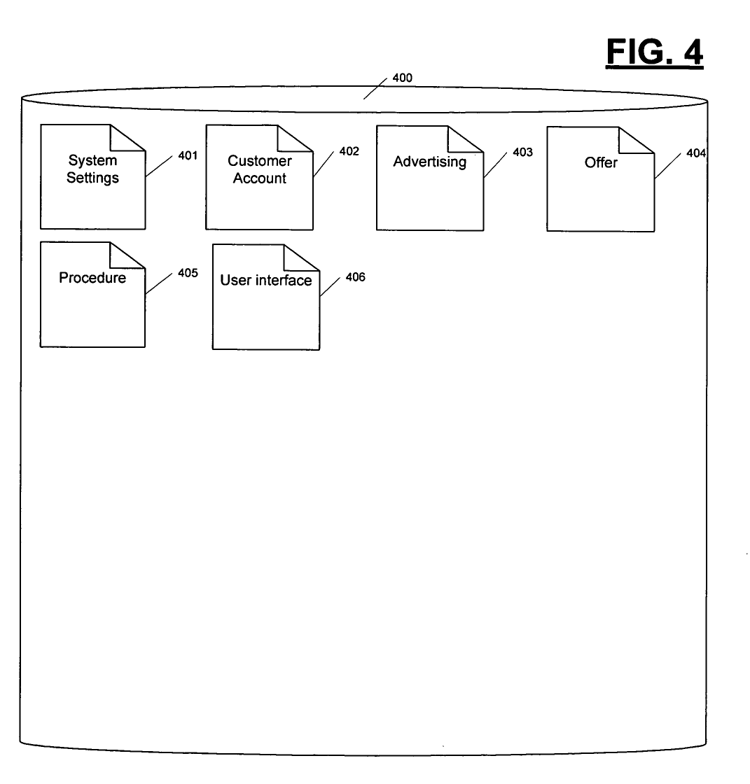

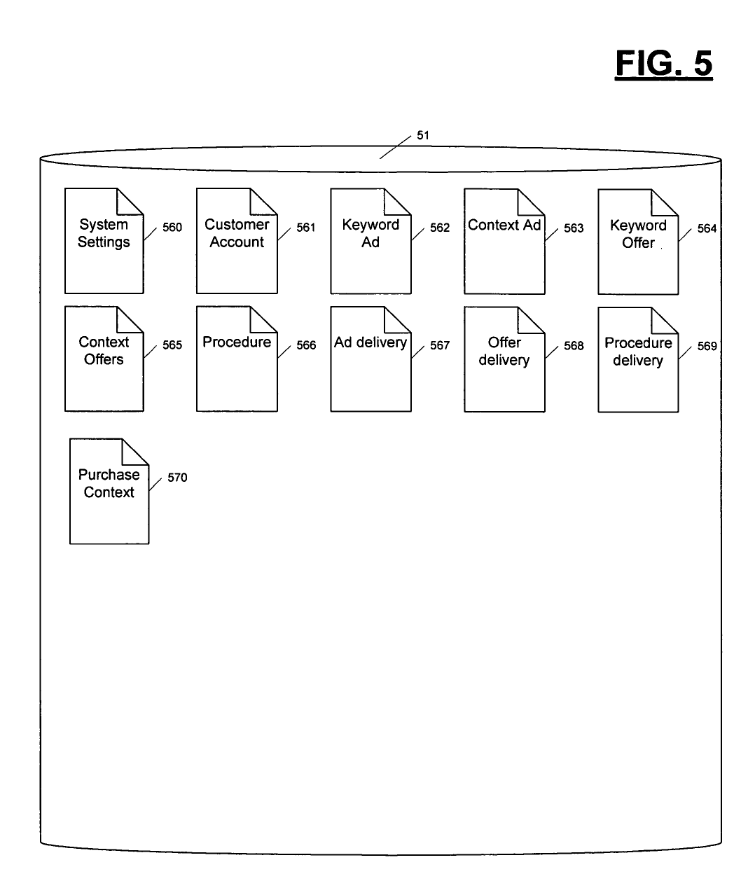

The fourth improvement to the personalized medicine service (10) and the entity context system (30) involves the automated identification of a general lexicon layer for an entity. The lexicon layer identification is completed in 3 distinct stages. First, the 10,000 most common words or symbols for the primary language of the user (20) are added to these systems as a baseline lexicon layer during system initialization. These baseline listings are developed in an automated fashion from one or more of the readily available corpora for a number of languages (i.e. English, Spanish, German, Egyptian Arabic, Mandarin Chinese, French, Japanese, Farsi, Hindi, Korean, Turkish, Vietnamese, etc.) in an automated fashion that is well known. The words or symbols contained in the entity's data are then analyzed and compared to the baseline listings to identify words that need to be added to the lexicon layer, words that are used with a significantly higher frequency than normal and to identify word associations. Finally, the words in the user's lexicon that are associated with the other layers of context are mapped (or added) to the lexicon layer as required to fully integrate semantic data to the context models (i.e. see FIG. 2A, FIG. 2B or FIG. 3 in cross referenced U.S. patent application Ser. No. 10/717,026).

The fifth improvement is that the personalized medicine service (10) and the entity context system (30) communicate regularly with the Complete Context™ Commerce System (50) during its operation. More specifically, the user (20) can choose to have the entity context system (30) communicate with the Complete Context™ Commerce System (50) at up to three distinct times:
1. when a context search has been completed;
2. when a Complete Context™ Scout Service (616) identifies a decision that requires more information; and/or
3. when a user's context changes—this includes when a purchase transaction is completed.

The benefits of enabling this communication will be detailed below.

As shown in FIG. 1, the entity context system (30) links via a network connection (45) with an entity context system for a service provider (40), a product company (60), a retailer (70) and/or a media company (80). While only one instance of each type of company is shown it is to be understood that the entity context system (30) can interface and interact with a plurality of each type of company that is using a context system or a functional equivalent. Because the systems (40, 60, 70 and 80) for these companies are identical to the entity context system (30)—save for the fact that the entity being supported is different—the previously identified improvements are also incorporated in their functionality and operation. As shown in FIG. 1, the entity context system (30) also links via a network connection (45) with a world wide web (33) and a public search engine (36) such as Google, Technorati, Yahoo, MSN, Ask, Exalead, Looksmart, Beyond.com and/or AltaVista. While only one public search engine is shown it is to be understood that the system can interface and interact with a plurality of public search engines (36) including vertical search engines as well as non-public search engines such as those used for enterprise search.

The final system in the intelligent personalized commerce chain is a Complete Context™ Commerce System (50). The operation of the Complete Context™ Commerce System (50) will be detailed below as part of the description of how the intelligent personalized commerce chain enables and supports the completion of each of the five steps of personalized commerce shown in FIG. 2. In one embodiment, the Complete Context™ Commerce System (50) is comprised of a network of computers (310, 320 and 330) and an application software segment (200). As shown in FIG. 3, one embodiment of a network of computers is a user-interface personal computer (310) connected to an application-server computer (320) via a network (45). The application server computer (320) is in turn connected via the network (45) to a database-server computer (330). The user interface personal computer (310) is also connected via the network (45) to an internet browser appliance (90) that contains browser software (800) such as Opera or Mozilla Firefox.

The database-server personal computer (330) has a read/write random access memory (331), a hard drive (332) for storage of the application database (51), a keyboard (333), a communications bus card containing all adapters and bridges (334), a display (335), a mouse (336) and a CPU (337).

The application-server personal computer (320) has a read/write random access memory (321), a hard drive (322) for storage of the application software (200) described herein, a keyboard (323), a communications bus containing all adapters and bridges (324), a display (325), a mouse (326), a CPU (327) and a printer (328). While only one client personal computer is shown in FIG. 3, it is to be understood that the application-server personal computer (320) can be networked to fifty or more client personal computers (310) via the network (45). The application-server personal computer (320) can also be networked to fifty or more server, personal computers (330) via the network (45).

Again, it is to be understood that the diagram of FIG. 3 is merely illustrative of one embodiment described herein as the computer system network (50) and application software (200) could reside on a single computer or any number of computers that are linked together using a network or grid. In a similar manner a system operator (21) and/or a customer (22) could interface directly with one or more of the computers in the system (50) instead of using an access device (90) with a browser (800) as described in the one embodiment. Along these same lines, the service provider (40), product company (60), retailer (70) and/or a media provider (80) could link only to the Complete Context™ Commerce System without linking directly to the entity context system (30).

The user-interface personal computer (310) has a read/write random access memory (311), a hard drive (312) for storage of a customer data table and the user-interface portion of the application software (200), a keyboard (313), a communications bus containing all adapters and bridges (314), a display (315), a mouse (316), a CPU (317) and a printer (318).

The application software (200) controls the performance of the central processing unit (327) as it completes the calculations used to support the advertising, configuring, offering, selling, delivering and/or servicing of offerings (information, media, products and/or services) that are appropriate to the context of a specific entity. In the embodiment illustrated herein, the application software program (200) is written in a combination of C# and Java although other languages can be used to the same effect. The customer (22) and system operator (21) can optionally interact with the application software (200) using the browser software (800) in the browser appliance (90) to provide information to the application software (200) for use in completing one or more of the steps in the intelligent personalized commerce chain.

User input is initially saved to the client database (49) before being transmitted to the communication bus card (324) and on to the hard drive (322) of the application-server computer (320) via the network (45). Following the program instructions of the application software (200), the central processing unit (327) accesses the user input by retrieving it from the hard drive (322) using the random access memory (321) as computation workspace in a manner that is well known.

The computers (310, 320 and 330) shown in FIG. 3 illustratively are personal computers or any of the more powerful computers (such as workstations or mainframe computers) that are widely available. Typical memory configurations for client personal computers (310) used with the present invention should include at least 2056 megabytes of semiconductor random access memory (311) and at least a 160 gigabyte hard drive (312). Typical memory configurations for the application-server computer (320) used with the present invention should include at least 5128 megabytes of semiconductor random access memory (121) and at least a 250 gigabyte hard drive (122). Typical memory configurations for the database-server computer (330) used with the present invention should include at least 10256 megabytes of semiconductor random access memory (331) and at least a 500 gigabyte hard drive (332).

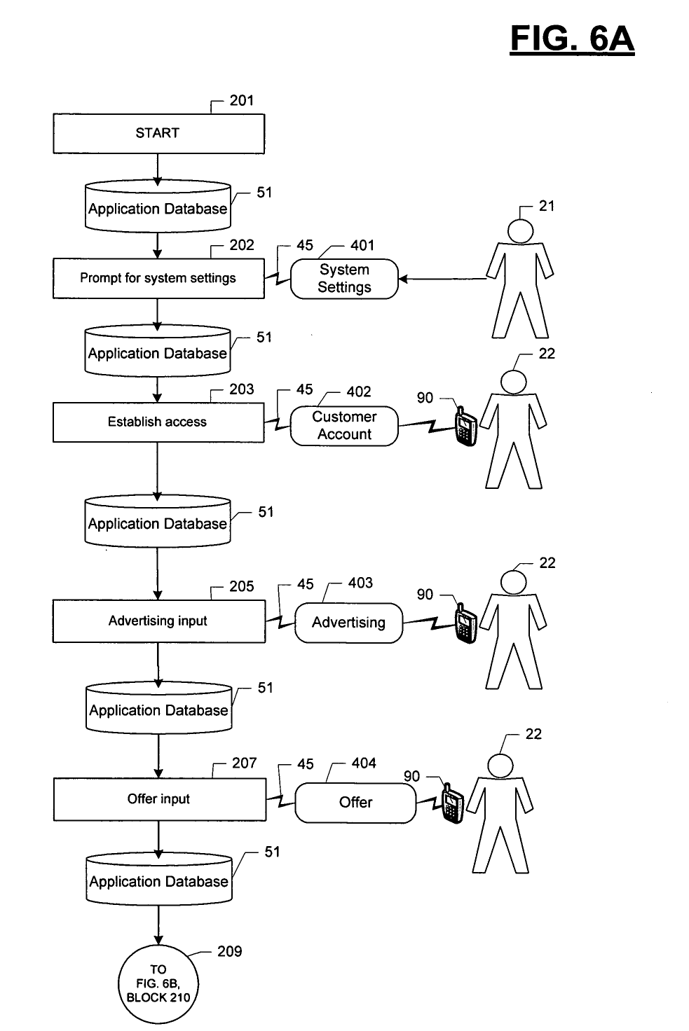

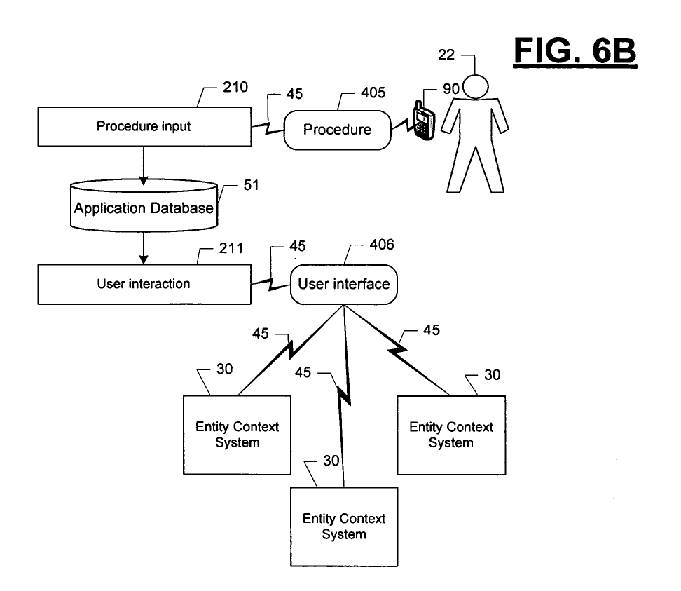

Using the systems described above, entity data are combined with data from a media company (80), a retailer (70), a service provider (40), a product company (60), the world wide web (33) and/or a public search engine (36) in the Complete Context™ Commerce System (50) and analyzed before the data and information required to complete a step of the intelligent personalized commerce chain is developed and/or transmitted to the entity context system (30). As detailed below, the data and information required to complete all or part of some steps can in some cases be completed without the Complete Context™ Commerce System (50). FIG. 6 details the processing that supports the completion of one or more of the steps in the personalized commerce chain.

### System Operations

The flow diagrams in FIG. 6A and FIG. 6B details the processing by the Complete Context™ Commerce System (50) required to support the completion of the each of the steps in the personalized commerce chain.

The personalized medicine service (10) described in U.S. patent application Ser. No. 11/094,171 and the entity context system (30) described in cross referenced U.S. patent application Ser. No. 10/717,026 each contain a number of features, services and/or systems (hereinafter, services) that support one or more of the five steps in the personalized commerce chain. The table below shows some of the specific services that support each step.

TABLE 1

| Commerce Chain Step | Support | Detailed description |
|---|---|---|
| Advertise (100) | Complete Context ™ | Identifies data, information and/or |
| | Search (609) alone or | knowledge relevant to entity |
| | with other services | context - can be used to |
| | | dramatically improve keyword |
| | | linked ads and/or enable context |
| | | linked ads/offers |
| Advertise (100) | Complete Context ™ | Identifies data, information and/or |
| | Scout (616) alone or | knowledge relevant to pending |
| | with other services | entity decisions - can be used to |
| | | dramatically improve keyword |
| | | linked ads and/or enable context |
| | | linked ads/offers |
| Advertise (100) | Complete Context ™ | Identifies newly developed data, |
| | Journal (630) alone or | information and/or knowledge |
| | with other services | relevant to entity context - can be |
| | | used to dramatically improve |
| | | keyword linked ads and/or enable |
| | | context linked ads/offers |
| Configure (110) | Complete Context ™ | Identifies one or more sets of |
| | Customization Service | features that should be included in |
| | (621) alone or with other | or expressed by an offering for an |
| | services | entity for a given context frame or |
| | | sub-context frame. |
| Configure (110) | Complete Context ™ | Guides one or more collaborators |
| | Capture and | through a series of steps in order |
| | Collaboration Service | to capture information, refine |
| | (622) alone or with other | existing knowledge and/or develop |
| | services | plans for the future. |
| Offer (120) | Complete Context ™ | A summary of entity context using |
| | Summary Service (617) | a Universal Context Specification |
| | alone or with other | that can be used to develop an |
| | services | offer. |
| Offer (120) | Complete Context ™ | Identifies an optimal* set of |
| | Optimization Service | features that should be included in |
| | (604) alone or with other | or expressed in an offer to an |
| | services | entity for a given context frame or |
| | | sub-context frame. |
| Sell (130) | Complete Context ™ | Identifies desirable exchanges of |
| | Exchange Service (608) | resources, elements, |
| | alone or with other | commitments, data and |
| | services | information with other entities in an |
| | | automated fashion |
| Sell (130) | Complete Context ™ | Completes sales transactions |
| | Input Service (601) | |
| | alone or with other | |
| | services | |
| Produce/Deliver (140) | Complete Context ™ | Identifies and develops securities |
| | Underwriting Service | and transactions that support |
| | (620) alone or with other | entity performance |
| | services | |
| Produce/Deliver (140) | Complete Context ™ | Analyzes and optimizes the impact |
| | Project Service (606) | of a project or a group of projects |
| | alone or with other | on a context frame (note: project is |
| | services | broadly defined to include any |
| | | development or diminution of any |
| | | components of context). |
| Produce/Deliver (140) | Complete Context ™ | Service for establishing measure |
| | Planning Service (605) | priorities, establish action |
| | alone or with other | priorities, and expected |
| | services | performance levels for actions, |
| | | events, elements resources and |
| | | measures. |
| Produce/Deliver (140) | Complete Context ™ | Service for reviewing components |
| | Review Service (607) | of context and entity measures |
| | alone or with other | alone or in combination. |
| | services | |
| Produce/Deliver (140) | Complete Context ™ | Service for forecasting the value of |
| | Forecast Service (603) | specified variable(s) using data |
| | alone or with other | from all relevant context layers |
| | services | with a multivalent combination of |
| | | forecasts from a tournament of |
| | | different approaches |

*optimal offer can be determined for a single entity or a plurality of entities

Before going further it is important to note that the ability to complete processing using these services depends on the user (20) giving permission to expose the required information via the Complete Context™ Display Service (614). Bots can also be used to complete one or more of the steps in the personalized commerce chain processing as detailed in cross referenced U.S. patent application Ser. No. 10/242,154 and one or more of the other cross referenced applications.

Most of the key terms have already been defined in one or more cross referenced applications. However, the terms used to describe the intelligent, personalized commerce chain have not been defined so we will define them in below before detailing the operation of the Complete Context™ Commerce System (50. The definitions are as follows:

1. Advertise—to announce or provide information about an offering in a communication in order to induce an entity to buy, lease, rent and/or use said offering;

2. Article—an instance of media included in a Complete Context™ journal for an entity;

3. Configure—to put together or arrange the parts of an offering in a specific way or for a specific purpose;

4. Keyword—a word or combination of words that will trigger the delivery of one or more advertisements, offers and/or processes to a user when it appears in an article, a search and/or a predictive search (aka Complete Context™ Scout);

5. Media—content from any source—i.e. articles from newspapers, video from TV. programs, recordings from radio programs, podcasts from radio and/or TV. programs, blog entries, pages from web sites, music from i-tunes; etc.

6. Offer—to present an offering for sale;

7. Offering—data, information, knowledge, media, product(s), service(s) and combinations thereof;

8. Produce/Deliver—to cause the existence and transfer of an offering;

9. Sell—to transfer an offering in exchange for consideration;

10. Service—a set of one or more activities;

With these definitions in place we will now detail the operation of the innovative system for Complete Context™ Commerce (50). System processing starts in a block 601, FIG. 6A, which immediately passes processing to a software block 602. The software in block 202 prompts the system operator (21) via a system settings data window (401) to provide a plurality of system setting information. The system setting information entered by the system operator (21) is transmitted via the network (45) back to the application server (320) where it is stored in a system settings table (560) in the application database (51) in a manner that is well known. The specific inputs the system operator (21) is asked to provide at this point in processing are shown in Table 1.

TABLE 1

| | |
|---|---|
| 1. | Metadata standard (XML or RDF) |
| 2. | Base currency for all pricing |
| 3. | Default missing data procedure |
| 4. | Maximum time to wait for user input |
| 5. | Source of conversion rates for currencies |
| 6. | Ads to accompany over-rides due to urgency? |
| | (specify cutoff level - if any) |

After the storage of system setting data is complete, processing advances to a software block 203.

The software in block 203 prompts each customer (22) via a customer account window (402) to establish an account and/or to open an existing account in a manner that is well known. For existing customers (22), account information is obtained from a customer account table (561). New customers (22) have their new information stored in the customer account table (561). After the customer (22) has established access to the system, processing advances to a software block 205

The software in block 205 prompts each customer (22) via an advertising window (403) to provide text, graphics and/or media that will be uploaded and stored for use in providing advertisements to an entity context system (30). There are two different types of ads that can specified by a customer (22)—keyword ads and context ads. Table 2 shows the different types of keyword ads that can be specified for an offering.

TABLE 2

| Type of ad | Information Provided | Trigger(s) |
|---|---|---|
| Defined keyword | Specific text, graphics | Use of a keyword in a context |
| | and/or media that should be | search and/or in an article |
| | presented in a device | |
| | specific format | |
| Customizable | Text, graphics and/or media | Use of a keyword in a context |
| Keyword | that should be presented in | search and/or in an article |
| | a format customized to the | |
| | user and device | |
| Defined user- | Specific text, graphics | Use of word that is linked in the |
| linked keyword | and/or media that should be | user's lexicon to a keyword used in |
| | presented in a device | a search and/or an article |
| | specific format | |
| Customizable | Text, graphics and/or media | Use of word that is linked in the |
| user-linked | that should be presented in | user's lexicon to a keyword used in |
| keyword | a format customized to the | a search and/or an article |
| | user and device | |
| Defined predictive | Specific text, graphics | Keyword related to an upcoming |
| keyword | and/or media that should be | decision being made by a user (20) |
| | presented in a device | |
| | specific format | |
| Customizable | Text, graphics and/or media | Keyword related to an upcoming |
| predictive keyword | that should be presented in | decision being made by a user (20) |
| | a format customized to the | |
| | user and device | |

Table 3 shows the two types of context ads. In both types of ads (keyword and context) the customization consists of selecting the best combination of material for the specific user and/or changing words that the customer (22) has indicated can be changed to match the user's lexicon.

TABLE 3

| Type of ad | Information Provided | Trigger(s) |
|---|---|---|
| Defined context ad | Specific text, graphics | The current context of a user |
| | and/or media that should be | matches a customer defined |
| | presented in a device | context within a defined |
| | specific format. | percentage. Context is defined |
| | | using one or more of the |
| | | components of context from a |
| | | universal context specification by |
| | | layer (note: percentage determined |
| | | using one of the simrank or |
| | | simfusion algorithms). |
| Customizable | Text, graphics and/or media | The current context of a user |
| context ad | that should be presented in | matches a customer defined |
| | a format customized to the | context within a defined |
| | user and device. Customer | percentage. Context is defined |
| | identifies words and/or | using one or more of the |
| | images that can be | components of context by layer |
| | changed as part of ad | from a universal context |
| | specification. | specification (note: percentage |
| | | determined using one of the |
| | | simrank or simfusion algorithms). |

As part of the input process, the customer (22) is also asked to identify the price that will be paid for each ad and an interruption limit. The interruption limit gives the customer (22) the option of preventing an ad from accompanying a report or search that over-rides the normal interruption limitations because of an identified urgency. The system operator (21) also has the ability to specify a limitation as part of the system settings process. The customer's input regarding keyword ads is stored in the application database (51) in a keyword ad material table (562) while the customer's input regarding context ads is stored in a context ad material table (563). After the advertising material has been stored, processing advances to a software block 207.

The software in block 207 prompts each customer (22) via an offer window (404) to define offers that will be provided to one or more users of an entity context system (30) that is linked to the Complete Context™ Commerce System (50). There are four different types of offers that can specified by a customer (22)—specific keyword, customized keyword, context specific and customized context offers. Table 4 shows more details about the different types of offers that can be specified for an offering.

TABLE 4

| Type of offer | Information Provided | Trigger(s) |
|---|---|---|
| Specific Keyword | Fixed offer - price (in base | Use of keyword in a search, use of |
| | currency), offering features | keyword in an article and/or a |
| | and delivery options | keyword related to an upcoming |
| | | decision being made by a user is |
| | | identified by a predictive search. |
| Customized | Price, offering features and | Use of keyword in a search, use of |
| Keyword | delivery options customized | keyword in an article and/or a |
| | to meet user requirements | keyword related to an upcoming |
| | and goals of customer. | decision being made by a user is |
| | Because this requires | identified by a predictive search. |
| | interaction between context | |
| | systems the process for | |
| | establishing interaction | |
| | between customer and user | |
| | systems is specified in next | |
| | step of processing. | |
| Context Specific | Fixed offer - price (in base | The current context of a user |
| | currency), offering features | matches a customer defined |
| | and delivery options | context within a defined |
| | | percentage. Context is defined |
| | | using one or more of the |
| | | components of context from a |
| | | universal context specification by |
| | | layer (note: percentage determined |
| | | using one of the simrank or |
| | | simfusion algorithms). |
| Customized | Price, offering features and | The current context of a user |
| Context | delivery options customized | matches a customer defined |
| | to meet user requirements | context within a defined |
| | and goals of customer. | percentage. Context is defined |
| | Because this requires | using one or more of the |
| | interaction between context | components of context from a |
| | systems the process for | universal context specification by |
| | establishing interaction | layer (note: percentage determined |
| | between customer and user | using one of the simrank or |
| | systems is specified in next | simfusion algorithms). |
| | step or processing. | |

As part of the input process, the customer (22) is also asked to identify the price that will be paid for each delivered offer and an interruption limit. Because the customized offers require interaction between a customer context system (40, 60, 70 or 80) and an entity context system (30) the customer (22) will be prompted to specify this procedure in the next stage of processing. The information defining the keyword offers is stored in a keyword offer table (564) while information defining the context offers is stored in a context offer table (565). After data storage is complete, processing advances to a software block 210.

The software in block 210 prompts each customer (22) via a procedure window (405) to define procedures that will be provided to one or more users (20) of an entity context system (30) that is linked to the Complete Context™ Commerce System (50). There are two different types of procedures that can specified by a customer (22)—offer procedures and information procedures. Table 5 shows more details the different types of procedures that can be specified by a customer (22).

TABLE 5

| Type of procedure | Information Provided | Trigger(s) |
|---|---|---|
| Offer | Method for interfacing with | Delivery of |
| | customer systems as | customized offer |
| | required to complete the | |
| | preparation of a customized | |
| | offer | |
| Information | Method for interfacing with | User response |
| | customer systems as | or request |
| | required to complete the | |
| | preparation of a customized | |
| | offer | |

As part of the input process, the customer (22) is also asked to identify the price that will be paid for each delivered procedure and an interruption limit. The information defining the procedures is stored in a procedure table (566). After data storage is complete, processing advances to a software block 211.

The software in block 211 provides the entity context system's (30) with advertisements, offers and/or procedures as appropriate for the context of each entity via a customer interface window (406) that establishes and maintains a connection with each entity context system (30) in a manner that is well known. As part of its processing, the software in block 211 may call on one or more Complete Context™ Services (625). Information about the delivery of advertisements for each customer is saved in an ad delivery table (567). Information about the delivery of offers for each customer is saved in an offer delivery table (568). Information about the delivery of procedures for each customer is saved in a procedure delivery table (569). The information from these three tables are used to prepare a bill for each customer in a manner that is well known. The monthly totals are saved in the customer account table (561). If the user (20) has allowed the Complete Context™ Commerce System (50) to track changes in context, then contexts that were associated with a purchase transaction will be captured and stored in a purchase context table (570) for dissemination to customers (22). This information will enable customers (22) to better identify contexts that are appropriate for Complete Context™ advertisements and will also allow the operators of the Complete Context™ Commerce System to receive payments for sales in addition to (or in place of) payments per ad, offer and/or procedure.

While the above description contains many specificities, these should not be construed as limitations on the scope of the invention, but rather as an exemplification of one embodiment thereof. Accordingly, the scope of the invention should be determined not by the embodiment illustrated, but by the appended claims and their legal equivalents.

What is claimed is:

1. A method for delivering information appropriate for an entity's context, the method comprising:
aggregating a plurality of entity related data in a format suitable for analysis;
analyzing at least a portion of said data as required to identify a context for said entity;
accepting and storing a plurality of information that are associated with one or more
keywords or contexts;
delivering at least a portion of said information to said entity under conditions selected from the group consisting of: an entity context matches a stored context, an article includes a stored keyword, a stored keyword is related to an upcoming decision that will be made by an entity, a word that is linked in the entity's lexicon to a stored keyword is used in a search, a word that is linked in the entity's lexicon to a stored keyword is used in an article, a stored keyword is used in a context search and combinations thereof
where the information is selected from the group consisting of offering related advertisements, offers, procedures and combinations thereof.

2. The method of claim 1 wherein a context for an entity further comprises a measure context and aspects of context selected from the group consisting of environment, resource, element, transaction, relationship, reference frame, lexicon and combinations thereof.

3. The method of claim 1 wherein analyzing entity related data as required to identify a context for said entity further comprises learning from said data as required to develop said context in an automated fashion.

4. The method of claim 1 wherein a keyword that is related to an upcoming decision that will be made by an entity is identified by a predictive search.

5. The method of claim 1 wherein an article further comprises an instance of media included in a Complete Context™ journal for an entity.

6. The method of claim 1 wherein delivering information to an entity further comprises delivering information in a format appropriate for a device being used by the entity.

7. The method of claim 1 wherein an offering further comprises items selected from the group consisting of data, information, knowledge, media, product(s), service(s) and combinations thereof.

8. A program storage device readable by machine, tangibly embodying a program of instructions executable by a machine to perform method steps for performing a customized offering method, the method steps comprising:
aggregating a plurality of entity related data in a format suitable for analysis; analyzing at least a portion of said data as required to identify a context for said entity where a context for an entity further comprises a reference frame and aspects of context selected from the group consisting of environment, resource, element, transaction, relationship, measure, lexicon and combinations thereof;
accepting and storing a plurality of information that are associated with one or more keywords or contexts; and
providing at least a portion of said stored information to said entity based on a keyword or context match
where an entity is selected from the group consisting of individual, group, organization or combination thereof.

9. The program storage device of claim 8 wherein the method further comprises:
creating a customized offering for an entity after receiving one or more favorable
responses to the stored information provided; and
completing a sales transaction after receiving a favorable response to said offering.

10. The program storage device of claim 9 wherein completing a sales transaction further comprises developing an offering, delivering an offering and receiving payment.

11. The program storage device of claim 9 wherein an offering further comprises items selected from the group consisting of data, information, knowledge, media, product(s), service(s) and combinations thereof.

12. The program storage device of claim 8 wherein a keyword or context match further comprise conditions selected from the group consisting of: an entity context matches a stored context, an article includes a stored keyword, a stored keyword is related to an upcoming decision that will be made by an entity, a word that is linked in the entity's lexicon to a stored keyword is used in a search, a word that is linked in the entity's lexicon to a stored keyword is used in an article, a stored keyword is used in a context search and combinations thereof

13. The program storage device of claim 8 wherein a plurality of information that are associated with one or more keywords or contexts further comprise information that is selected from the group consisting of offering related advertisements, offer, procedures and combinations thereof.

14. The program storage device of claim 8 wherein a reference frame further comprises a virtual reference frame, a physical reference frame or a combination thereof.

15. A Complete Context™ advertisement, comprising an advertisement for an offering that is delivered to an entity only when a context of said entity matches a predefined context.

16. The Complete Contextυ advertisement, of claim 15 wherein a context for an entity further comprises a transaction context and aspects of context selected from the group consisting of environment, resource, element, measure, relationship, reference frame, lexicon and combinations thereof.

17. The Complete Context™ advertisement of claim 15 wherein an offering further comprises items selected from the group consisting of data, information, knowledge, media, product(s), service(s) and combinations thereof.

18. The Complete Context™ advertisement of claim 15 wherein a match of an entity context with a predefined context further comprises a match within a predefined percentage.

19. The Complete Context™ advertisement of claim 15 wherein a match of an entity context with a predefined context further comprises a match within a predefined percentage where the percentage match is determined by an algorithm selected from the group consisting of suffusion, weighted suffusion, trusted suffusion, shrank, weighted shrank, trusted shrank and combinations thereof.

20. The Complete Context™ advertisement of claim 15 that further comprises an advertisement that is pre-defined or customized to match an entity context, characteristic or combination thereof.

21. An intelligent, personalized commerce chain apparatus, comprising a plurality of entity context systems, a Complete Context™ Commerce System, a personalized medicine service and means for interconnecting said systems and service where a plurality of entity context systems further comprise a plurality of context systems for entities selected from the group consisting of retailer, media company, service provider, product company, individual, group, organization and combinations thereof.

22. The apparatus of claim 21 that supports activities selected from the group consisting of: defined keyword advertising, customizable keyword advertising, defined user-linked keyword advertising, customizable user-linked keyword advertising, defined predictive keyword advertising, customizable predictive keyword advertising, defined context advertising, customizable context advertising, specific keyword offers, customized keyword offers, context specific offers, customized context offers, procedure distribution, customized offering development, customized offering delivery, customized offering sale and combinations thereof.
